(19) United States
(12) Patent Application Publication
(10) Pub. No.: US 2004/0133806 A1
(43) Pub. Date: Jul. 8, 2004

(54) Integration of a Wireless Local Area Network and a Packet Data Network

(76) Inventors: Donald Joong, Montreal (CA); Uzma Abbas, Laval (CA); Raj Sanmugam, Ottawa (CA); Dipankar Ray, Dorval (CA)

Correspondence Address: ALEX NICOLAESCU, Ericsson Canada Inc., Patent Department (LMC/M/P), 8400 Decarie Blvd., Town Mount Royal, QC, H4P 2N2, CA

(21) Appl. No.: 10/623,638

(22) Filed: Jul. 22, 2003

Related U.S. Application Data
(60) Provisional application No. 60/417,176, filed on Oct. 10, 2002.

(51) Int. Cl. H04L 9/00

(52) U.S. Cl. 713/201; 713/150

(57) ABSTRACT

The present invention relates to method for integrating a Wireless Local Area Network (WLAN) and a Wireless Wide Area Network (WWAN) and to a Wireless Local Area Network Serving Node (WSN) therefore. For doing so, the WSN receives Remote Authentication Dial-In User Service (RADIUS) Request message from an Access Point (AP), the RADIUS Request message including terminal's credentials. The WSN proxies the RADIUS Request message at a RADIUS proxy capability. The WSN authenticates the terminal using the terminal's credentials. The WSN manages charging operation for the terminal.

### PRIORITY STATEMENT UNDER 35 U.S.C S.119 (e) & 37 C.F.R. S.1.78

This non-provisional patent application claims priority based upon the prior U.S provisional patent application entitled “SIM AKA BASED AUTHENTICATION (using 802.1×)”, application No. 60/417,176, filed Oct. 10, 2002, in the name of Donald Joong, Uzma Abbas, and Raj Sanmugam.

### BACKGROUND OF THE INVENTION

1. Field of the Invention

The invention relates to a method for providing security in a Multi-Access Network Environment that integrates a Wireless Local Area Network and a Packet Data Network.

2. Description of the Related Art

As of today, Wireless Local Area Networks (WLANs) are deployed by hotspot service providers in different public places such as shopping malls, hotels or airports. A WLAN allows a user of a wireless client (laptop or desktop computer equipped with PC or PCI cards) to access a plurality of services. More particularly, PC or PCI cards receive radio signals from an Access Point (AP) with which it is communicating and translates that signal into digital data that PCs can understand. In the WLAN, APs are provided for granting access to the user. APs are hard-wired to a LAN such as an Ethernet network. Also, APs can be described as software that run on a server, however the vast majority of APs are separate pieces of hardware. APs translate digital data from the network into radio signals that wireless clients can understand for providing services to a user, while within the coverage of the WLAN.

WLANs use unregulated frequencies. This can provide to a user a greater data speed. For example APs and wireless clients can communicate over channels within a 2.4 GHz frequency band. Channel 2 in the 2.4 GHz band runs specifically at 2.402 GHz. Channel 3 runs at 2.403 GHz. The 2.4 GHz frequency band has a total of 80 channels, however some countries such as the United States and Canada allow the use of different frequencies. In these mentioned countries channels 1 through 11 are used.

The Multi-Access Environment solution defines an integration of a WLAN and a third generation (3G) digital cellular network such as CDMA2000 or UMTS (Universal Mobile Telecommunication System), which are fully integrated for data/voice transmission. Therefore, a 3G network's operator can offer WLAN services to their subscribers and this depending on their location. However, WLAN access and 3G networks' access are completely independent access technologies. For that reason, 3G networks require a complement for deploying a WLAN hotspot coverage within the broader 3G wide area coverage and for allowing mobile users to roam from a WLAN to a 3G network and vice versa. For doing so, the Multi-Access Environment solution uses Mobile IP along with an introduction of a WLAN Serving Node (WSN). The WSN is connected to APs via switched Ethernet, which is a connection of a plurality of Local Area Networks. Alternatively, the WSN can be connected to APs via wired lines or radio links.

The original 802.11 WLAN standard developed by IEEE, which is included herewith by reference, was developed for WLAN access for personal network such as Local Area Networks (LANs) and not for WLAN access for WLAN that are deployed in a larger area such as Wide Area Networks (WANs) or 3G networks. Thus, the original 802.11 WLAN standard lacks a secure mechanism for access authentication. For that reason, the IEEE association has developed the 802.1X Port based Authentication mechanism, which is also included herewith by reference. The 802.1X specification describes a method of denying link layer access (of the 802.11 protocol) from a wireless client to an AP until authentication is successfully performed.

The 802.1X specification proposes a framework, whereby there exists 3 entities: a supplicant, an authenticator or network port and an authentication server. A supplicant is an entity that desires to use a service (MAC connectivity) offered via a port on the authenticator. Thus on a single network there would be many ports available through which the supplicant can authenticate the service. The supplicant authenticates via the authenticator to an authentication server. An authentication following 802.1X works as follows: a) the supplicant sends a start message to an authenticator, which in turn requests the identity of the client; b) the supplicant replies with a response packet containing the identity, and the authenticator forwards to an authentication server a packet containing the identity of the supplicant; c) the authentication server sends an “accept” packet to the authenticator; and d) upon reception of the “accept” packet, the authenticator places the supplicant in authorized state and traffic is allowed to proceed.

For instance, in a Multi-Access Environment solution that follows 802.1X, a terminal would be the supplicant, an AP would be the authenticator and an AAA server would be the authentication server. However, in the context of Multi-Access Environment solution, the proposed 802.1X framework does not fit very well with the introduction of a WSN. Ideally the WSN should be responsible for the authenticator role. It should have the role of granting network access to a terminal. Doing this also provides security between the AP and the WSN. More particularly, in a LAN deployment, the AP and the WSN would be on a same link layer LAN, and 802.1X could be extended between the terminal and the WSN. Consequently, the WSN would be designated as the authenticator instead of the AP.

In a WAN deployment such as in a LAN deployment, security between a WSN and an AP must be provided. However, in the WAN deployment the WSN is remotely situated from the AP. As a result, the 802.1X link layer cannot be extended beyond an AP's LAN. For that reason, the WSN cannot be designated as the authenticator in a WAN deployment. Therefore, there is a need to provide the authenticator role to the WSN in a Multi-Access Environment solution. The invention provides a solution to this problem.

### SUMMARY OF THE INVENTION

It is therefore one broad object of this invention to provide a method for integrating a Wireless Local Area Network (WLAN) and a Wireless Wide Area Network (WWAN), the method comprising steps of:

sending a Service Request message from a terminal to an Access Point (AP);

starting a WLAN access procedure between the terminal and the AP;

sending a Remote Authentication Dial-In User Service (RADIUS) Request message from the AP to a WLAN Serving Node (WSN), the RADIUS Request message including terminal's credentials;

proxying at a RADIUS proxy capability of the WSN the RADIUS Request message;

authenticating the terminal at the WSN using the terminal's credentials; and

managing at the WSN access control for the terminal.

It is therefore another broad object of his invention to provide a Wireless Local Area Network Serving Node (WSN) for authenticating a terminal, the WSN being capable of:

receiving a Remote Authentication Dial-In User Service (RADIUS) Request message from an Access Point (AP), the RADIUS Request message including terminal's credentials;

proxying the RADIUS Request message at a RADIUS proxy capability;

authenticating the terminal using the terminal's credentials; and

managing charging operations for the terminal.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is illustrating a Multiple Access Environment that integrates a Wireless Local Area Network (WLAN) and a Third Generation (3G) Wireless Wide Area Network (WWAN) in accordance to the invention;

FIG. 2 is a flow chart showing a method for integrating a WLAN and a 3G WWAN in accordance to the invention; and

FIG. 3 is a signal flow diagram illustrating a flow of messages for integrating a WLAN and a 3G WWAN in accordance to the invention.

### DETAILED DESCRIPTION OF THE PREFERRED EMBODIMENTS

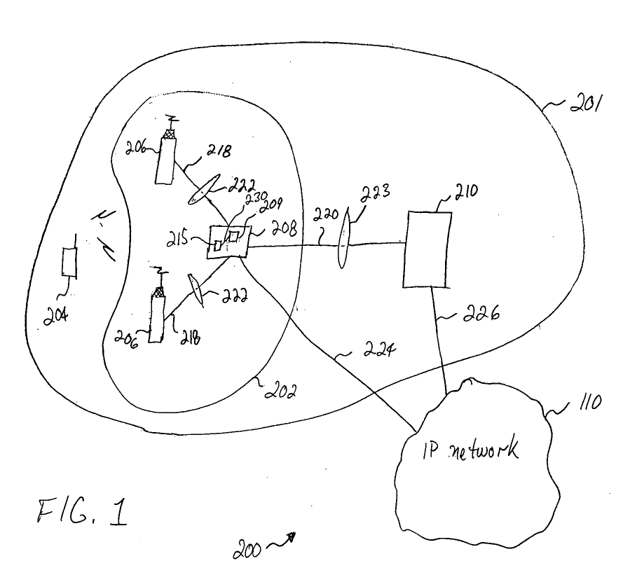

Reference is now made to FIG. 1, which illustrates a Multiple Access Environment 200 that integrates a Wireless Local Area Network (WLAN) 202 and a Third Generation (3G) Wireless Wide Area Network (WWAN) 201 in accordance to the invention. The 3G WWAN 201 is a packet data network such as for example a Code Division Multiple Access 2000 (CDMA2000) network. In the Multi Access Environment 200, a terminal 204 may roam back and forth from the WLAN 202 to the 3G WWAN 201 and vice versa. The terminal 204 is registered in the 3G WWAN 201 and operable in both the WLAN 202 and in the 3G WWAN 201. The terminal 204 can be for example a mobile telephone, a Personal Data Application (PDA), a laptop computer or desktop computer equipped with an access card. It is assumed that the terminal 204 is Simple IP capable and Mobile IP capable. Mobile IP and Simple IP access are well known in the art and are defined by Third Partnership Project 2 (3GPP2) standards.

The terminal 204 is granted access to the WLAN 202 via at least one of possibly many APs 206. The AP 206 acts as an authenticator for the terminal 204 in the WLAN 202. The AP 206 is responsible for receiving signals from the terminal 204 and sending signals to the terminal 204 on an Internet Protocol (IP) connection over an air interface. The AP 206 is connected via an IP connection 218 to a WLAN Serving Node (WSN) 208, which comprises a Remote Authentication Dial-In User Service (RADIUS) proxy capability 209 for access control and charging purposes that is connected via 230 with a RADIUS client 215 for sending RADIUS messages. The WSN 208 can be used as a gateway responsible for managing IP services and for maintaining session information for the terminal 204. The invention supports basic RADIUS accounting requirements as defined in Internet Engineering Task Force (IETF) RFC 2138, which is included herewith by reference.

In FIG. 1, a Wide Area Network (WAN) 222, such as Internet or an Ethernet network, interfaces IP connections 218. As a result, the WSN 208 is remotely situated from the APs 206. The WSN 208 also communicates via a connection 220 with a Home Authentication, Authorization and Accounting server (H-AAA) 210 located in the 3G WWAN 201. A WAN 223 such as the WAN 222 interfaces the IP connection 220. The H-AAA 210 is responsible for authenticating and authorizing subscriber accessing the network 201. For example in CDMA2000 network and WLAN accesses, the H-AAA 210 also serves as a repository for accounting data. The H-AAA 210 contains profile of data entries for every subscriber registered in the 3G WWAN 201. The H-AAA 210 and the WSN 208 are ultimately connected via IP connections 224 and 226 to an IP network 110 such as Internet for providing IP services to the terminal 204 (e.g. Internet access). It has been stated that the terminal 204 may roam back and forth from the WLAN 202 to the 3G WWAN 201. It can also be understood that the terminal 204 may roam in a visited network (not shown) of the 3G WWAN 201. More particularly, when the terminal 204 is roaming in the visited network of the 3G WWAN 201, the H-AAA 210 authenticates the terminal 204 via a Foreign AAA (not shown) located in the visited network where the terminal 204 is roaming. Following this, accounting information is sent back to its home billing system (not shown). Consequently, it can be understood that the invention is not limited to the number of nodes or the shown connections in FIG. 1.

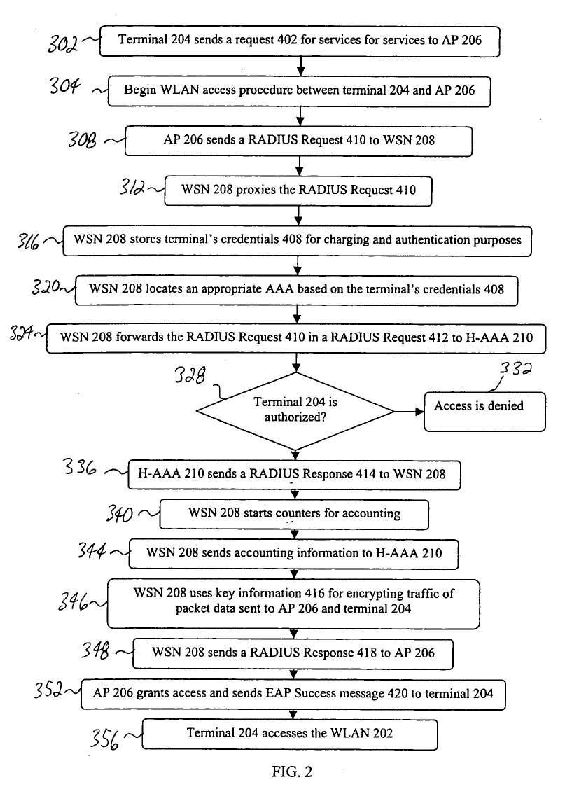

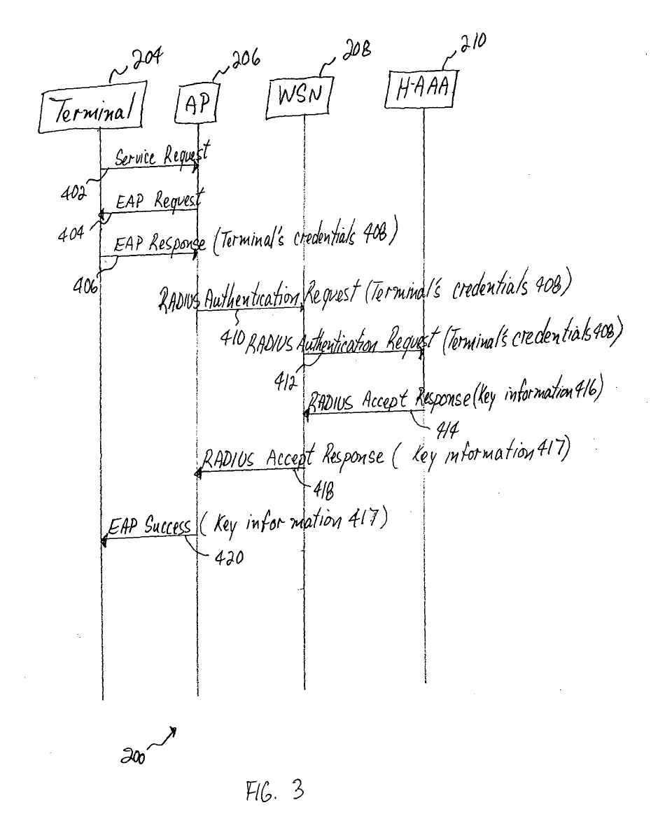

Reference is now made to FIG. 2, which is flow chart that shows a method for integrating the WLAN 202 and the 3G WWAN 201 in accordance to the invention and further to FIG. 3, which is a signal flow diagram illustrating a flow of messages for integrating the WLAN 202 and a 3G WWAN 201 in accordance to the invention.

The terminal 204 obtains access to the WLAN 202 by first sending a request 402 to the AP 206 for requesting services (step 302). At step 304, the WLAN process begins and the AP 206 sends an Extensible Authentication Protocol (EAP) Request message 404 to the terminal 204 for requesting its credentials (e.g. User name or MAC address, Service-Type, NAS-Identifier, Domain Name Server, etc). The terminal 204 further replies to the message 404 with an EAP Response message 406 including its credentials 408.

Following this, the AP 206 sends the terminal's credentials 408 in a RADIUS Authentication Request message 410 to the WSN 208 for granting access to the terminal 204 (step 308). Since the AP 206 is connected to the WSN 208 via a Wide Area Network (WAN), the WSN 208 is remotely situated from the AP 206 and thus the link layer LAN 802.1X cannot be extended beyond the AP 206. For that reason, the WSN 208 proxies the message 410 by using the RADIUS proxy capability 209 (step 312) for obtaining an IP address for the H-AAA based on the terminal's credentials. At step 316, the WSN 208 stores the terminal's credentials 408 for charging and authentication purposes. More particularly at step 316, the WSN 208 keeps one charging record for all sessions for the terminal 204 and is capable of forwarding this information to an appropriate AAA of the terminal 204 and if needed other billing gateway (not shown). Doing this at the WSN 208 can avoid re-authentication if an authentication timer has not been expired and if the terminal 204 moves to a new AP. As a result, an unnecessary authentication is avoided. Alternatively, the WSN 208 can also buffer traffic sent to the terminal 204 and may redirect the traffic if needed to the new AP. Afterwards, the WSN 208 maintains access control to the network when the terminal 204 is in WLAN mode and has all the appropriate information for charging data generation for a duration of an IP session.

In order to locate the appropriate AAA (H-AAA 210) in the 3G WWAN 201 for authenticating and to authorizing the terminal 204 in the 3G WWAN 201, the WSN 208 uses the terminal's credentials 408 (e.g. Domain Name Server) at step 320. Next, the WSN 208 forwards the RADIUS Authentication Request message 410 in a RADIUS Authentication Request message 412 including the terminal's credential 408 to the H-AAA 210 (step 324). The H-AAA 210 uses the terminal's credentials 408 for authenticating and authorizing the terminal 204 (step 328). If the terminal 204 is not authorized for accessing services in the WLAN 202 and 3G WWAN 201, the H-AAA 210 denies the access and the message 412 is rejected (step 332). Alternatively, the WSN 208 can maintain a list of terminals that have failed to perform authentication on the basis of their credentials (e.g. MAC address or user name). If the terminal 204 fails to perform authentication for a determined number of time with in a certain time limit the terminal will be put in a “doubtful” list and if the terminal 204 fails to perform more than a threshold value then it will be put on a “bad list”. Next, if the terminal 204 wants to perform authentication (i.e. a RADIUS Authentication Request message) the message will not be forwarded towards the H-AAA 210. When the terminal 204 is on “doubtful” list and a RADIUS Authentication Request message comes from that user the RADIUS Authentication Request message will be forwarded in a vendor specific attribute for marking the terminal 204. This may help the H-AAA 210 for keeping a list. Furthermore, the H-AAA 210 may send a failure number to other WSNs using the vendor specific attribute in a broadcast message.

However, if the terminal 204 is authorized the H-AAA 210 responds to the RADIUS Authentication Request message 412 with a RADIUS Accept Response message 414 (step 336). Upon reception of the message 414, the WSN 208 starts counters for accounting for the IP session (step 340) and may send this information to the H-AAA 210. At step 344, this information is sent to the H-AAA 210 based on a common single billing scheme that cover all access types (WLAN and 3G WWAN). The Multi-Access Environment 200 allows operators and/or users to configure their subscription with either different or common billing schemes, depending on the access type used (WLAN or 3G WWAN). Consequently, the billing may be based on time, duration, and volume of packet data downloaded or destination type.

Wireless Equivalency Protection (WEP), which is supported by the 802.1X for access authentication in a WLAN, provides encryption of traffic of packet data between a terminal and an AP. However, this solution does not provide an encryption of the traffic of packet data between the terminal and a WSN.

In particular, since the message 414 is returned to the WSN 208, it is also possible to provide a mechanism for key distribution for encryption of traffic of packet data that is sent from the WSN 208 to the terminal 204 and vice versa. As it is well known in the art and particularly in the IS 835-A standard, the H-AAA 210 generates and assigns a key for each IP session. Therefore, the message 414 includes a key information 416. The key information 416 may comprise a code and necessary data for enabling a generation of a key information and for encrypting and decrypting packet data. Hence, the WSN 208 uses the key information 416 for generating a key to be used for encrypting the traffic of packet data between the between the terminal 204 to the WSN 208 (step 346). The encryption and decryption is performed using known protocols such as IPsec. Performing step 346 provides an additional level of security in addition to the WEP in the Multi-Access Environment 200. At step 348, the WSN 208 sends key information 417 in a RADIUS Accept Response message 418 to the AP 206 (step 348). Following this, the AP 206 grants access to the to the WLAN 202 to the terminal 204 and thus sends the key information 417 in an EAP Success message 420 to the terminal 204 (step 352) and the terminal 204 accesses the WLAN 202 (step 356).

The invention gives an example of the integration of the WLAN 202 based on the 802.1X and the EAP protocols and the 3G WWAN 201 that is a Code Division Multiple Access (CDMA2000) network. However, it can also be understood that any 3G WWAN such as any Global System Mobile/Universal Mobile Telecommunication System (GSM/UMTS) network could have been used instead of the CDMA2000 network.

Although several preferred embodiments of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for integrating a Wireless Local Area Network (WLAN) and a Wireless Wide Area Network (WWAN), the method comprising steps of:
sending a Service Request message from a terminal to an Access Point (AP);
starting a WLAN access procedure between the terminal and the AP;
sending a Remote Authentication Dial-In User Service (RADIUS) Request message from the AP to a WLAN Serving Node (WSN), the RADIUS Request message including terminal's credentials;
proxying at a RADIUS proxy capability of the WSN the RADIUS Request message;
authenticating the terminal at the WSN using the terminal's credentials; and
managing at the WSN access control for the terminal.

2. The method of claim 1, wherein the method further comprises steps of:
locating in the WWAN a Home-Authentication, Authorization, and Accounting (Home-AAA) server;
sending a RADIUS Request message from the WSN to H-AAA, the RADIUS Request message including the terminal's credentials;
authenticating the terminal at the Home-AAA; and
sending from the Home-AAA to the WSN a RADIUS Request message, the RADIUS Request message including a key information.

3. The method of claim 2, wherein the method further comprises steps of:
receiving the key information at the WSN; and
sending from the WSN to the AP a RADIUS Accept Response message, the RADIUS Accept Response message including a key information.

4. The method of claim 3, wherein the step of receiving comprises a step of generating a key at the WSN for encrypting and decrypting traffic of packet data between the WSN and the terminal.

5. The method of claim 1, wherein the step of starting further comprises steps of:
sending from the AP to the terminal an Extensible Authentication Protocol (EAP) Request message; and
receiving at the AP an EAP Response from the terminal.

6. The method of claim 5, wherein the step of receiving further comprises steps of:
granting access to the WLAN to the terminal; and
sending an EAP Success message from the AP to the terminal.

7. The method of claim 1, wherein the step of managing further comprises steps of:
starting counters in the WSN; and
sending accounting information from the WSN to the Home-AAA.

8. A Wireless Local Area Network Serving Node (WSN) for authenticating a terminal, the WSN being capable of:
receiving a Remote Authentication Dial-In User Service (RADIUS) Request message from an Access Point (AP), the RADIUS Request message including terminal's credentials;
proxying the RADIUS Request message at a RADIUS proxy capability;
authenticating the terminal using the terminal's credentials; and
managing charging operations for the terminal.

9. The WSN of claim 8, wherein the WSN is further capable of:
locating in the WWAN Home-Authentication, Authorization, and Accounting (Home-AAA) server; and
sending to the Home-AAA a RADIUS Request message, the RADIUS Request message including the terminal's credentials.

10. The WSN of claim 8, wherein the WSN is further capable of receiving from the Home-AAA a RADIUS Response message, the RADIUS Response message including a key information.

11. The WSN of claim 10, wherein the WSN is further capable of using the key information for generating a key for encrypting and decrypting traffic of packet data between the WSN and the terminal.

12. The WSN of claim 8, wherein the WSN is further capable of:
sending a RADIUS Response message to the AP, the RADIUS Response message, the RADIUS Response message including key information.

13. The WSN of claim 8, wherein the WSN is further capable of:
starting counters for accounting; and
sending accounting information to the H-AAA.
